(19) United States
(12) Patent Application Publication
(10) Pub. No.: US 2004/0128961 A1
(43) Pub. Date: Jul. 8, 2004

(54) Filter bag and method of manufacture thereof

(75) Inventor: Alan F. Lapoint, Scarborough, ME (US)

Correspondence Address: PATRICK R. SCANLON, PIERCE ATWOOD, ONE MONUMENT SQUARE, PORTLAND, ME, 04101, US

(73) Assignee: U.F. Strainrite Corporation

(21) Appl. No.: 10/742,032

(22) Filed: Dec. 19, 2003

Related U.S. Application Data
(63) Continuation-in-part of application No. 10/143,659, filed on May 10, 2002.

(51) Int. Cl. B01D 46/02

(52) U.S. Cl. 55/381

(57) ABSTRACT

A filter bag is provided having a body comprising a filter media of stiffened nonwoven fabric. A method of manufacturing a filter bag comprising a filter media of stiffened nonwoven fabric is also provided.

### CROSS REFERENCES TO RELATED APPLICATIONS

This application is a continuation-in-part of copending application Ser. No. 10/143,659, filed May 10, 2002.

### BACKGROUND OF THE INVENTION

This invention relates generally to filters for fluids and more particularly to bag filters.

It is known to filter fluids, for example particle-laden liquids, using open-mouthed bags formed out of porous fabrics. In one known arrangement, a porous fabric bag has an open mouth seated on an annular shoulder in a rigid tubular duct. Liquid flows through the open mouth of the bag into the bag interior space. Particulates are trapped in the pores of the fabric bag, while the liquid flows through the porous bag wall into the annular space formed between the duct side wall and the bag side surface. Bag filters have certain advantages over types of filters, for example cartridge filters, because of their inside-to-outside fluid flow path, which allows them to hold more particulate material before becoming too clogged for further use.

Porous fabrics for use as a filter media in filter bags may be made from woven fibers or from nonwoven fibers. Nonwoven fibers are generally considered superior to woven fibers in filtering efficiency, as they present more usable filtering area than a woven fabric for a filter bag of a given size. In order to filter fluids of relatively high viscosity, such as ink, paint bases, etc., a differential pressure must be applied across the filter bag. Unfortunately, this differential pressure tends to compress or squeeze the fabric, which reduces the thickness (loft) of the fabric, similar to the manner in which the pores of a sponge are closed when it is compressed. This tends to obstruct the flow through the filter bag.

Accordingly, there is a need for a filter bag which is resistant to compression when used to filter high viscosity fluids.

### BRIEF SUMMARY OF THE INVENTION

The above-mentioned need is met by the present invention, which in one aspect provides a filter bag having a body comprising a filter media comprising stiffened nonwoven fabric. In another aspect, the present invention provides a method of manufacturing a filter bag comprising a filter media of stiffened nonwoven fabric.

The present invention and its advantages over the prior art will become apparent upon reading the following detailed description and the appended claims with reference to the accompanying drawings.

### BRIEF DESCRIPTION OF THE DRAWINGS

The subject matter that is regarded as the invention is particularly pointed out and distinctly claimed in the concluding part of the specification. The invention, however, may be best understood by reference to the following description taken in conjunction with the accompanying drawing figures in which:

FIG. 1 is a schematic side view of a filter bag constructed in accordance with the present invention.

FIG. 2 is top view of the filter bag of FIG. 1.

FIG. 3 is a schematic perspective view of a sheet of filter media used to construct the filter bag of the present invention.

FIG. 4 is a schematic perspective view of a tube formed from the filter media of FIG. 3.

FIG. 5 is a schematic perspective view of a filter blank cut from the tube of FIG. 4.

FIG. 6 is a top view of an exemplary sealing ring for use with the filter bag of the present invention.

FIG. 7 is a view taken along lines 7-7 of FIG. 6.

FIG. 8 is a schematic perspective view of a tube formed from the filter media of FIG. 3 showing an alternative type of seam.

### DETAILED DESCRIPTION OF THE INVENTION

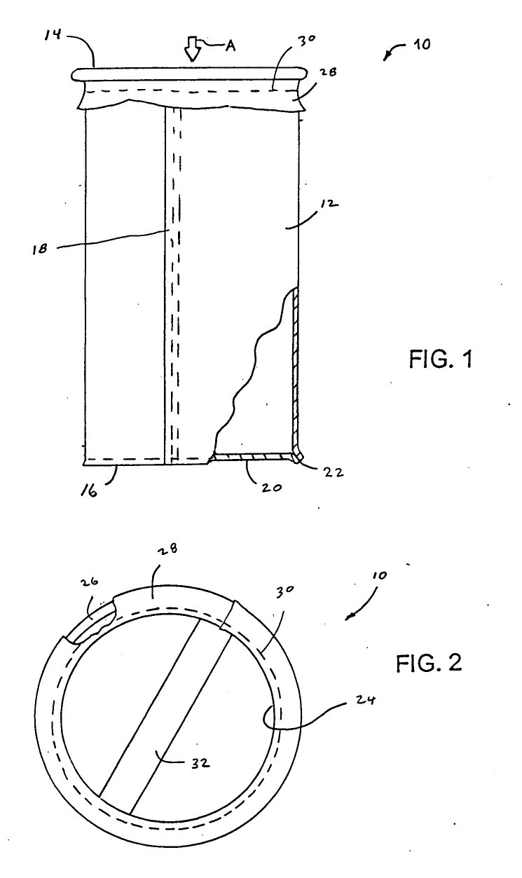

Referring to the drawings wherein identical reference numerals denote the same elements throughout the various views, FIG. 1 illustrates a filter bag 10 constructed in accordance with the present invention. The filter bag 10 is generally in the shape of a container with an open top and a closed bottom. In one embodiment, the filter bag 10 has a substantially cylindrical body 12 which includes a top end 14 and a bottom end 16. The body 12 is formed from a single piece of filter media cut in an appropriate shape and rolled into a cylindrical tube with opposing edges joined together by a side seam 18 extending from the top end 14 to the bottom end 16. The filter bag 10 further comprises a bottom disk 20 joined to the bottom end 16 of the body 12, thereby closing the bottom of the filter bag 10. The body 12 and the disk 20 are joined together by a bottom seam 22 that extends around the circumference of the filter bag 10. The disk 20 is a circular piece of filter media, which is preferably the same filter media that the body 12 is made of, having roughly the same diameter as the body 12. The seams 18 and 22 may be sealed by any known manner, for example by stitching, thermal bonding, or ultrasonic welding.

The filter bag 10 can be a single-walled filter, as depicted in FIG. 1, or a multi-walled filter. For instance, a double-walled filter bag would comprise a second cylindrical body fitted inside the body 12 with a second bottom disk joined thereto and disposed inside of the bottom disk 20. In this case the respective side seams of the two cylindrical bodies would be staggered (that is, not circumferentially aligned) to prevent the possibility of particulates passing through needle holes of each seam.

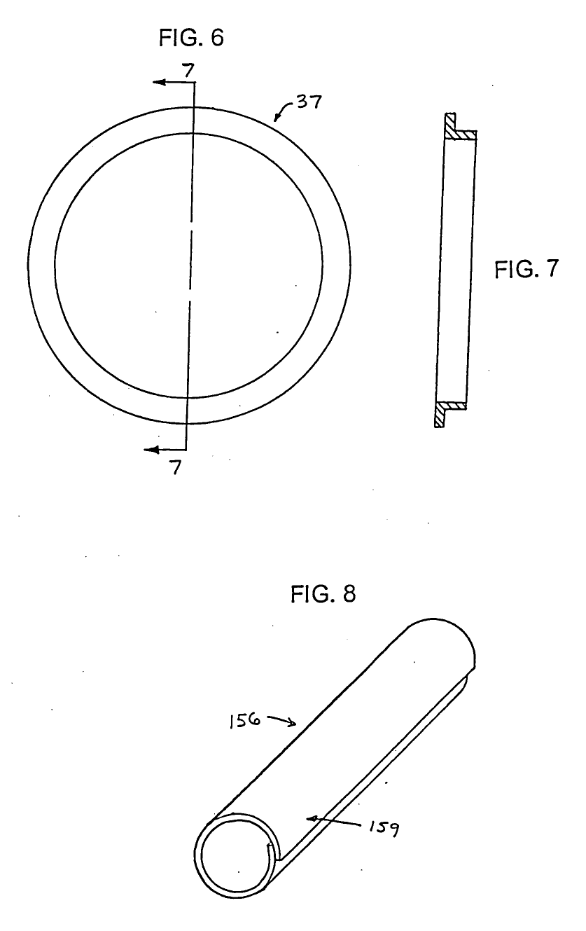

Referring to FIG. 2, the top end 14 of the body 12 forms a generally circular opening 24. The opening 24 is supported by a sealing ring 26 attached to the top end 14 by a cuff collar 28 (shown in partial cut-away in FIG. 2 to reveal the sealing ring 26). The cuff collar 28 is a piece of fabric that is folded over the sealing ring 26 and secured to the top of the body 12 with stitching 30. The purpose of the sealing ring 26 is to provide the filter bag 10 with a rigid edge to seat inside a known filter canister or housing (not shown) into which the filter bag 10 is installed for use. Any shape which provides a rigid edge for sealing may be used for the sealing ring 26, for example a ring having a round cross-section as illustrated in FIG. 2, or a circular flange 27 having an L-shaped cross-section, as illustrated in FIGS. 6 and 7. Furthermore, the sealing ring 26 may be formed from any relatively rigid material, such as metal or plastic. The cuff collar 28 can be made of a fabric, such as polyester or the like, that is more flexible than the filter media of the body 12, thereby facilitating seating the sealing ring 26 in the filter housing. A strap 32 can be stitched inside the body 12 and across the opening 24 to provide a means for lifting the filter bag 10.

The body 12 and the disk 20 comprise a stiffened nonwoven filter media. As used herein, the term “stiffened nonwoven filter media” means any porous, nonwoven fabric which is suitable for filtering particulate material from a fluid flow and which has been treated with a stiffening agent which coats the fibers of the fabric, so as to make the treated media stiffer (i.e. less compressible) than the untreated media.

Examples of suitable fabrics include those comprising polypropylene, polyester, rayon, cellulose, or acrylic fibers, or combinations thereof. The pore size of the fabric may be varied to suit a particular application and typically ranges from about 0.5 microns to about 200 microns. Examples of suitable stiffening agents include phenolic resins, epoxy resins, and melamine resins. The particular stiffening agent used is not critical, and any stiffening agent which is able to coat the fibers of the fabric, and which when cured stiffens the structure of the fibers without significantly clogging the pores of the fabric, may be used. One example of a fabric that may be treated as described above is a needled nonwoven micron-rated polyester fabric, available from Globetec Nonwovens, 40 Industrial Drive, North East, Md. 21901 U.S.A. Suitable phenolic treating services are available from Knowlton Nonwovens, Inc., 3694 Clarkston Road, Suite B, Clarkston, Mich. 48348 U.S.A.

In operation, the filter bag 10 is placed into a suitable filter housing of a known type and secured thereto. Fluid is directed into the filter bag 10 at the opening 24 in the direction of the arrow labeled A in FIG. 1, and passes downward through the filter bag 10. The filter media allows the passage of the fluid through the body 12 and the disk 20, while retaining particles of undesired material in the interior of the filter bag 10. When filtering a fluid with relatively high viscosity such as a paint base or ink, a differential pressure, for example about 69 kPa (10 psi) to about 172 kPa (25 psi), is applied to force the fluid flow through the filter bag 10. The differential pressure tends to make the fibers of the filter bag 10 compress and lose their loft, which reduces the effective surface area of the filter bag 10 and tends to restrict the flow of fluid. The stiffened nonwoven filter media of the present invention resists this tendency to collapse and ensures free flow of the fluid. Thus, the full benefits of the bag filter design and a nonwoven filter media are obtained.

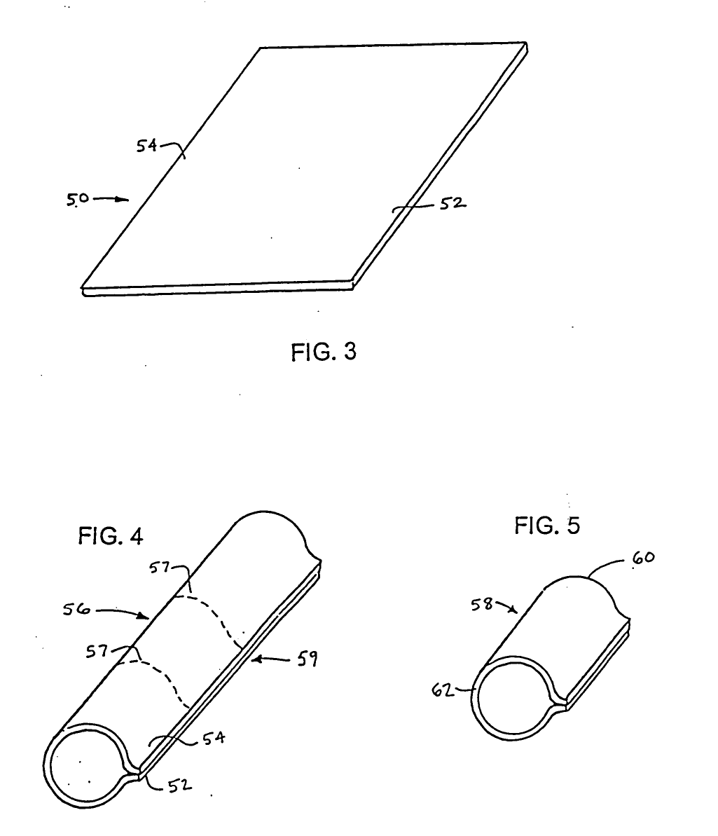

FIGS. 3-5 illustrate an exemplary process by which the filter bags 10 of the present invention may be manufactured using available automated tube-forming equipment. First, untreated filter media 50 (see FIG. 3) is processed using known tube-forming equipment. The media 50, which is provided in flat sheets having longitudinal edges 52 and 54, is folded over itself to form a continuous, generally cylindrical tube 56 (see FIG. 4). The edges of the tube 56 are then brought together to form a longitudinal seam 59 and sealed together at the longitudinal seam 59, for example by known stitching, thermal bonding, or ultrasonic welding methods. Any known type of seam may be used. For example, FIG. 4 shows an abutting seam, while FIG. 8 shows a tube 156 having an overlapping seam 159 which is equally suitable. In the illustrated example the tube 56 has a diameter of about 17.8 cm (7 in.) Although the tube 56 is depicted as having a finite length in FIG. 4, the tube forming process may be a continuous process, and the length of the tube 56 is only limited by the length of available filter media 50. Subsequently, the tube 56 is treated with a stiffening agent (described above), for example by immersing the tube 56 in the stiffening agent, and the stiffening agent is allowed to cure. Alternatively, the untreated filter media 50 can be treated with the stiffening agent prior to being formed into the tube 56. The treated tube 56 is then cut into appropriate lengths (for example at cut lines 57) to produce cylindrical filter blanks 58, shown in FIG. 5, each having first and second ends 60 and 62. In the illustrated example the filter blank 58 is about 40.6 cm (16 in.) long.

Next, another piece of untreated filter media is cut into one or more circular disks having a diameter roughly equivalent to the diameter of the cylindrical filter blanks 58. The circular disks are treated with a stiffening agent (described above), for example by immersion in the stiffening agent, and the stiffening agent is allowed to cure. Alternatively, the untreated filter media can be treated with the stiffening agent prior to being cut into one or more disks. A circular disk is the joined to the first end 60 of the blank 58 by stitching, thermal bonding, or ultrasonic welding, to form a closed end, and a sealing ring is attached to the second end 62 with a collar cuff (described above) to define an open end.

The foregoing has described a filter bag having a body comprising a filter media of stiffened nonwoven fabric, and a method of manufacturing a filter bag comprising a filter media of stiffened nonwoven fabric. While specific embodiments of the present invention have been described, it will be apparent to those skilled in the art that various modifications thereto can be made without departing from the spirit and scope of the invention as defined in the appended claims.

What is claimed is:

1. A filter bag comprising a substantially cylindrical body having first and second ends and a disk joined to one of said first and second ends to form a closed bottom, said body and said disk comprising a stiffened nonwoven filter media.

2. The filter bag of claim 1 wherein said stiffened nonwoven filter media comprises porous nonwoven fabric treated with a stiffening agent.

3. The filter bag of claim 2 wherein said stiffening agent comprises a phenolic resin.

4. The filter bag of claim 2 wherein said porous nonwoven fabric comprises fibers selected from the group consisting of: polypropylene, polyester, rayon, cellulose, and acrylic fibers, and combinations thereof.

5. The filter bag of claim 2 wherein said porous nonwoven fabric comprises polyester fibers.

6. A method of manufacturing a filter bag, comprising:
providing a first piece of filter media which comprises a porous nonwoven fabric;
treating said first piece of filter media with a stiffening agent;
forming said first piece of filter media into a tube;
providing a second piece of filter media which comprises a porous nonwoven fabric;
treating said second piece of filter media with a stiffening agent;
forming said second piece of filter media into a disk; and
joining said second piece of filer media to a first end of said tube.

7. The method of manufacturing a filter bag of claim 6 wherein said step of forming said first piece of filter media into a tube includes forming said first piece of filter media into a generally cylindrical shape such that a first longitudinal edge and a second longitudinal edge of said filter media are in contact with each other, and joining said first and second longitudinal edges to each other.

8. The method of manufacturing a filter bag of claim 7 wherein said step of joining said first and second longitudinal edges to each other comprises stitching said first longitudinal edge to said second longitudinal edge.

9. The method of manufacturing a filter bag of claim 6, further comprising attaching a sealing ring to a second end of said tube.
